(19) United States
(12) Patent Application Publication
(10) Pub. No.: US 2026/0213240 A1
(43) Pub. Date: Jul. 23, 2026

(54) ION CONDUCTOR DISPERSION, POLYMER ELECTROLYTE MEMBRANE PREPARED THEREFROM, MEMBRANE-ELECTRODE ASSEMBLY, AND FUEL CELL

(71) Applicant: KOLON INDUSTRIES, INC., Seoul (KR)

(72) Inventors: Jung Hwa PARK, Seoul (KR); Dong-Hoon LEE, Seoul (KR); Kum Suck SONG, Seoul (KR); Sung-Hyun YUN, Seoul (KR); Seung Jib YUM, Seoul (KR); Chang Hoon OH, Seoul (KR); Hye Song LEE, Seoul (KR); Eun Su LEE, Seoul (KR)

(21) Appl. No.: 19/139,937

(22) PCT Filed: Mar. 31, 2023
(86) PCT No.: PCT/KR2023/004413

§ 371 Date: Jun. 17, 2025

(30) Foreign Application Priority Data
Apr. 20, 2022 (KR) 10-2022-0048833
Mar. 28, 2023 (KR) 10-2023-0040450

(51) Int. Cl. H01M 8/1039; C08J 5/22; H01M 8/10; H01M 8/1004; H01M 8/1032; H01M 8/106

(52) U.S. Cl. CPC H01M 8/1039; C08J 5/225; H01M 8/1004; H01M 8/1032; H01M 8/106; C08J 2323/30; H01M 2008/1095; H01M 2300/0082; H01M 2300/0094

(57) ABSTRACT

Provided is an ion conductor dispersion capable of improving the chemical and mechanical durability of a polymer electrolyte membrane. The ion conductor dispersion according to the present disclosure includes an ion conductor, a crosslinking agent, and a solvent, and has a contact angle of at most 135° with respect to a polytetrafluoroethylene (PTFE) porous membrane. Here, the contact angle is measured 1 second after the ion conductor composition is dropped on the polytetrafluoroethylene (PTFE) porous membrane under the conditions of 25° C. and a relative humidity of 60%.

### TECHNICAL FIELD

The present disclosure relates to an ion conductor dispersion, a polymer electrolyte membrane manufactured therefrom, a membrane-electrode assembly, and a fuel cell, and more particularly, to an ion conductor dispersion that improves mechanical and chemical durability of a polymer electrolyte membrane, a polymer electrolyte membrane manufactured therefrom, a membrane-electrode assembly, and a fuel cell.

### BACKGROUND ART

A fuel cell is a cell equipped with a power generation system that directly converts chemical reaction energy such as oxidation/reduction reaction of hydrogen and oxygen contained in hydrocarbon-based fuels such as methanol, ethanol, or natural gas, into electrical energy, and has attracted attention as a next-generation clean energy source capable of replacing fossil energy due to its high energy efficiency and environmentally friendly characteristics such as emission of a small amount of pollutant.

Such a fuel cell has the advantage of being able to produce a wide range of outputs through a stack configuration formed by stacking unit cells, and exhibits an energy density 4 to 10 times higher than that of a small lithium battery. Thus, the fuel cell has attracted attention as a compact and portable power source.

The stack that substantially generates electricity in a fuel cell has a structure in which several to dozens of unit cells composed of a membrane-electrode assembly (MEA) and a separator (also referred to as a bipolar plate) are stacked, wherein the membrane-electrode assembly generally has a structure in which an anode (also referred to as a fuel electrode) and a cathode (also referred to as an air electrode) are disposed on both sides, respectively, of an electrolyte membrane with the electrolyte membrane interposed therebetween.

Fuel cells may be classified into alkaline electrolyte membrane fuel cells, polymer electrolyte membrane fuel cells (PEMFC), and the like, depending on the state and type of electrolyte. Among them, the polymer electrolyte membrane fuel cells have attracted attention as power sources for portable, automotive, and residential applications, due to advantages such as a low operating temperature below 100° C., fast startup and response characteristics, and excellent durability.

A representative example of the polymer electrolyte membrane fuel cell may include a proton exchange membrane fuel cell (PEMFC) that uses hydrogen gas as fuel, a direct methanol fuel cell (DMFC) that uses liquid methanol as fuel, and the like.

The following reaction may occur in the polymer electrolyte membrane fuel cell. First, when fuel such as hydrogen gas is supplied to an anode, hydrogen ions (H⁺) and electrons (e⁻) are generated by an oxidation reaction of hydrogen gas at the anode. The generated hydrogen ions are transferred to a cathode through a polymer electrolyte membrane, and the generated electrons are transferred to the cathode through an external circuit. At the cathode, oxygen gas is supplied, and combines with hydrogen ions and electrons to produce water by a reduction reaction of oxygen.

Meanwhile, numerous technical barriers remain to be addressed in order to achieve the commercialization of polymer electrolyte membrane fuel cells, and essential improvement factors include achieving high performance, long lifespan, and cost reduction. The component that has the greatest impact on these factors is the membrane-electrode assembly, among which the polymer electrolyte membrane is one of the key elements that most significantly affect the performance and cost of the MEA.

Requirements for the polymer electrolyte membrane necessary for operating the polymer electrolyte membrane fuel cell include high hydrogen ion conductivity, chemical stability, low fuel permeability, high mechanical strength, low moisture content, excellent dimensional stability, and the like.

In a conventional process for preparing an ion conductor dispersion used to manufacture the polymer electrolyte membrane, a crosslinking agent was not introduced, so the chemical and mechanical durability of the polymer electrolyte membrane was reduced during fuel cell operation. Even though crosslinking agents were introduced, crosslinking agents such as hexamethylenediamine and oxydianiline exhibited poor compatibility with perfluorosulfonic acid (PFSA) polymers. In particular, under high-temperature and low-humidity conditions, perfluorosulfonic acid polymers such as PFSA have the problems that their physical properties readily transform into a rubbery state at high temperatures, and hydrogen ion conductivity is rapidly reduced at low relative humidity.

### DISCLOSURE

### Technical Problem

An object of the present disclosure is to provide an ion conductor dispersion that improves the chemical and mechanical durability of a polymer electrolyte membrane.

Another object of the present disclosure is to provide a polymer electrolyte membrane manufactured using the ion conductor dispersion.

Still another object of the present disclosure is to provide a membrane-electrode assembly including the polymer electrolyte membrane having improved chemical and mechanical durability under high-temperature and low-humidity conditions.

Yet another object of the present disclosure is to provide a fuel cell including the membrane-electrode assembly.

The objects of the present disclosure are not limited to those mentioned above. Other objects and advantages of the present disclosure that are not mentioned will be understood from the following description and will be more clearly understood by the embodiments of the present disclosure. In addition, it will be readily appreciated that the objects and advantages of the present disclosure may be realized by the means and combinations thereof set forth in the claims.

### Technical Solution

To achieve the above object, according to a first aspect of the present disclosure, there is provided an ion conductor dispersion comprising: an ion conductor; a crosslinking agent; and a solvent, wherein a contact angle relative to a polytetrafluoroethylene (PTFE) porous membrane is 135° or less. Here, the contact angle is an angle measured 1 second after the ion conductor dispersion is dropped on the polytetrafluoroethylene (PTFE) porous membrane under conditions of 25° C. and a relative humidity of 60%.

According to a second aspect of the present disclosure, in the first aspect, the ion conductor may be any one selected from the group consisting of a fluorine-based ion conductor, a partially fluorine-based ion conductor, a hydrocarbon-based ion conductor, and a mixture thereof.

According to a third aspect of the present disclosure, in the first or second aspect, the crosslinking agent may include any one selected from the group consisting of a salicylic acid-based compound, a coumaric acid-based compound, terephthalic acid, 3-hydroxybenzoic acid, 4-hydroxybenzoic acid, and combinations thereof.

According to a fourth aspect of the present disclosure, in the third aspect, the salicylic acid-based compound may include any one selected from the group consisting of salicylsalicylic acid, acetylsalicylic acid, and combinations thereof.

According to a fifth aspect of the present disclosure, in any one of the first to fourth aspects, the crosslinking agent may be included in an amount of 0.05 to 20 parts by weight, based on 100 parts by weight of the ion conductor.

According to a sixth aspect of the present disclosure, in any one of the first to fifth aspects, the polar solvent may be any one selected from the group consisting of distilled water, an alcohol solvent, tetrahydrofuran, 1,4-dioxane, dimethyl acetamide, dimethyl formamide, dimethyl sulfoxide, methylene chloride, and a mixture thereof.

According to a seventh aspect of the present disclosure, in the sixth aspect, the polar solvent may be any one selected from the group consisting of distilled water, an alcohol solvent, tetrahydrofuran, 1,4-dioxane, dimethyl acetamide, dimethyl formamide, dimethyl sulfoxide, methylene chloride, and a mixture thereof.

According to an eighth aspect of the present disclosure, in the sixth aspect, the nonpolar solvent may be any one selected from the group consisting of n-hexane, 1,1,2,2-tetrachloroethane, 1,2-dichloroethane, chloroform, and a mixture thereof.

According to a ninth aspect of the present disclosure, in any one of the first to eighth aspects, a solubility of the crosslinking agent in the solvent may be 0.5 to 400 g/L under conditions of 20 to 30° C. and a relative humidity of 50 to 70%.

According to a tenth aspect of the present disclosure, in any one of the first to ninth aspects, a dielectric constant of the solvent may be 48 or less.

According to an eleventh aspect of the present disclosure, in any one of the first to tenth aspects, the contact angle of the ion conductor dispersion with respect to the PTFE porous membrane may be 10 to 130°

According to a twelfth aspect of the present disclosure, in any one of the first to eleventh aspects, a polymer electrolyte membrane manufactured using the ion conductor dispersion according to any one of the first to eleventh aspects may be provided.

According to a thirteenth aspect of the present disclosure, in the twelfth aspect, the polymer electrolyte membrane may include a porous support, wherein the porous support may be impregnated with the ion conductor dispersion.

According to a fourteenth aspect of the present disclosure, a membrane-electrode assembly comprising the polymer electrolyte membrane according to the twelfth or thirteenth aspect; and a catalyst layer disposed on at least one surface of the polymer electrolyte membrane may be provided.

According to a fifteenth aspect of the present disclosure, a fuel cell comprising the membrane-electrode assembly according to the fourteenth aspect may be provided.

### Advantageous Effects

According to an embodiment of the present disclosure, the chemical and mechanical durability of the polymer electrolyte membrane may be improved, and the present disclosure can be readily applied to the manufacturing process of the polymer electrolyte membrane, such that the efficiency and economic feasibility of the process can be achieved. In particular, according to an embodiment of the present disclosure, a polymer electrolyte membrane having improved durability under high temperature and low humidity conditions may be provided.

In addition to the above-mentioned effects, the specific effects of the present disclosure will be described in conjunction with the specific content for carrying out the present disclosure below.

### BRIEF DESCRIPTION OF DRAWINGS

FIG. 1 is a cross-sectional view showing a polymer electrolyte membrane according to an embodiment of the present disclosure.

FIG. 2 is a cross-sectional view showing a membrane-electrode assembly according to an embodiment of the present disclosure.

FIG. 3 is a schematic view for illustrating a fuel cell according to an embodiment of the present disclosure.

### MODE FOR DISCLOSURE

Hereinafter, each configuration of the present disclosure will be described in more detail so that a person having ordinary knowledge in the art to which the present disclosure belongs can easily carry out the present disclosure, but this is only one example, and the scope of the rights of the present disclosure is not limited by the following contents.

An ion conductor dispersion according to an embodiment of the present disclosure includes an ion conductor, a crosslinking agent, and a solvent, and may have a contact angle of 135° or less with respect to a polytetrafluoroethylene (PTFE) porous membrane. The contact angle of the ion conductor dispersion with respect to the PTFE porous membrane is measured 1 second after the ion conductor dispersion is dropped on the PTFE porous membrane under conditions of 25° C. and a relative humidity of 60%.

Hereafter, the configuration of the present disclosure will now be described in more detail.

### 1. Ion Conductor Dispersion

An ion conductor dispersion according to the present disclosure includes an ion conductor, a crosslinking agent, and a solvent.

An ion conductor according to the present disclosure may be any one selected from the group consisting of a fluorine-based ion conductor, a partially fluorine-based ion conductor, a hydrocarbon-based ion conductor, and a mixture thereof.

The fluorine-based ion conductor may be, for example, any one selected from the group consisting of a fluorine-based polymer containing fluorine atoms in a main chain, such as poly(perfluorosulfonic acid), poly(perfluorocarboxylic acid), a copolymer of tetrafluoroethylene and fluorovinyl ether including a sulfonic acid group, and a mixture thereof.

The partially fluorine-based ion conductor may be, for example, a polystyrene-graft-ethylene tetrafluoroethylene copolymer or a polystyrene-graft-polytetrafluoroethylene copolymer.

The hydrocarbon-based ion conductor may be, for example, any one selected from the group consisting of sulfonated polyimide (S-PI), sulfonated polyarylethersulfone (S-PAES), sulfonated polyetheretherketone (S-PEEK), sulfonated polybenzimidazole (S-PBI), sulfonated polysulfone (S-PSU), sulfonated polystyrene (S-PS), sulfonated polyphosphazene, sulfonated polyquinoxaline, sulfonated polyketone, sulfonated polyphenylene oxide, sulfonated polyether sulfone, sulfonated polyether ketone, sulfonated polyphenylene sulfone, sulfonated polyphenylene sulfide, sulfonated polyphenylene sulfide sulfone, sulfonated polyphenylene sulfide sulfone nitrile, sulfonated polyarylene ether, sulfonated polyarylene ether nitrile, sulfonated polyarylene ether ether nitrile, sulfonated polyarylene ether sulfone ketone, and a mixture thereof.

The crosslinking agent according to the present disclosure may include any one selected from the group consisting of a salicylic acid-based compound, a coumaric acid-based compound, terephthalic acid, 3-hydroxybenzoic acid, 4-hydroxybenzoic acid, and combinations thereof. Specifically, the salicylic acid-based compound may include, for example, any one selected from the group consisting of salicylsalicylic acid, acetylsalicylic acid, and combinations thereof. The coumaric acid-based compound may be, for example, any one selected from the group consisting of ortho-coumaric acid, meta-coumaric acid, para-coumaric acid, and combinations thereof.

In a conventional process for preparing an ion conductor, since a salicylic acid-based compound was not introduced as a crosslinking agent, the chemical and mechanical durability of a polymer electrolyte membrane manufactured using an ion conductor dispersion was reduced. Even though crosslinking agents were introduced into the ion conductor dispersion, crosslinking agents such as hexamethylenediamine and oxydianiline exhibited poor compatibility with PFSA polymers. In particular, under high-temperature and low-humidity conditions, perfluorosulfonic acid polymers such as PFSA have the problems that their physical properties readily transform into a rubbery state at high temperatures, and hydrogen ion conductivity is rapidly reduced at low relative humidity. According to an embodiment of the present disclosure, by introducing a salicylic acid-based compound as a crosslinking agent, unique effects may be achieved, such as excellent solubility in solvent and high compatibility with PFSA polymers. As a result, the crosslinking reaction between ion conductor compounds may be promoted, thereby minimizing a decrease in hydrogen ion conductivity and improving a mechanical durability of the polymer electrolyte membrane. In addition to the salicylic acid-based compound, each of the coumaric acid-based compounds, terephthalic acid, 3-hydroxybenzoic acid, and 4-hydroxybenzoic acid compounds may also perform the same function as the salicylic acid-based compound.

The crosslinking agent according to the present disclosure may be included in an amount of 0.05 to 20 parts by weight, preferably 0.1 to 5 parts by weight, and more preferably 0.5 to 3 parts by weight, based on 100 parts by weight of the ion conductor. When the content of the crosslinking agent is less than the above range, the chemical and mechanical durability of the polymer electrolyte membrane may not be sufficiently improved, and when the content of the crosslinking agent exceeds the above range, hydrogen ion conductivity may be excessively reduced, and some of the crosslinking agent may precipitate and act as a foreign substance.

The solvent according to the present disclosure may be any one selected from the group consisting of a polar solvent, a non-polar solvent, and a mixture thereof.

The polar solvent may be any one selected from the group consisting of distilled water, alcoholic solvents, tetrahydrofuran, 1,4-dioxane, dimethyl acetamide, dimethyl formamide, dimethyl sulfoxide, methylene chloride, and a mixture thereof.

The alcoholic solvent may be, for example, any one selected from the group consisting of methanol, ethanol, propanol, and butanol.

The non-polar solvent may be any one selected from the group consisting of n-hexane, 1,1,2,2-tetrachloroethane, 1,2-dichloroethane, chloroform, and a mixture thereof.

The solubility of the crosslinking agent in the solvent may be 0.5 to 400 g/L, preferably 1 to 300 g/L, and more preferably 2 to 150 g/L, under conditions of 20 to 30° C. and a relative humidity (RH) of 50 to 70%. When the solubility of the crosslinking agent is less than the above range, the crosslinking agent may precipitate when introduced into the polymer electrolyte membrane and may not act as a crosslinking agent, and when the solubility of the crosslinking agent exceeds the above range, the crosslinking agent may be lost during fuel cell operation, resulting in a lower degree of crosslinking lower than intended.

In other words, a dielectric constant of the solvent may be, for example, 48 or less at 20 to 25° C., specifically 1 to 48, and more specifically 5 to 48.

The contact angle of the ion conductor dispersion according to the present disclosure with respect to the polytetrafluoroethylene (PTFE) porous membrane may be 135° or less, preferably from 10° to 130°, and more preferably 20° to 125°, 80° to 120°, or 86° to 118°. The contact angle of the ion conductor dispersion with respect to the PTFE porous membrane may be measured 0.001 to 120 seconds, preferably 0.005 to 60 seconds, and more preferably 0.01 to 20 seconds after the ion conductor dispersion is dropped on the PTFE porous membrane under conditions of 20 to 30° C. and a relative humidity of 30 to 70%, and specifically may be measured 1 second after the ion conductor dispersion is dropped on the PTFE porous membrane under conditions of 25° C. and a relative humidity of 60%. For example, the contact angle of the ion conductor dispersion may be collectively affected by the type of the ion conductor and solvent, the presence or absence of the crosslinking agent, and the content of the crosslinking agent. Therefore, by appropriately adjusting the composition and content of the ion conductor, solvent, and crosslinking agent, respectively, it is possible to derive a contact angle of the ion conductor dispersion that improves the mechanical properties of the polymer electrolyte membrane and enhances the chemical durability of the membrane-electrode assembly.

The PTFE porous membrane may be, for example, a Teflon porous membrane. By satisfying the above range for the contact angle of the ion conductor dispersion with respect to the PTFE porous membrane, the crosslinking reaction may be performed well.

### 2. Polymer Electrolyte Membrane

Another embodiment of the present disclosure provides a polymer electrolyte membrane manufactured using the ion conductor dispersion. In this case, the polymer electrolyte membrane manufactured using the ion conductor dispersion may be a membrane in which an ion conductor dispersion is dried to remove the solvent, and a crosslinking reaction is performed to form a crosslinking matrix between the ion conductor and the crosslinking agent. According to another aspect of the present disclosure, the polymer electrolyte membrane may include a repeating unit derived from an ion conductor and a repeating unit derived from a crosslinking agent. For example, the crosslinked matrix may include a first ion conductor chain, a second ion conductor chain different from the first ion conductor chain, and a molecular structure derived from a crosslinking agent that crosslinks the first and second ion conductor chains. Here, through the molecular structure derived from the crosslinking agent, the first and second ion-conductive polymer chains may be connected to each other. For example, various known analytical methos such as ¹¹H-NMR, ¹³C-NMR, and FT-IR may be used to analyze the polymer electrolyte membrane.

Meanwhile, the first and second ion conductor polymer chains may include a crosslinkable functional group capable of crosslinking with the crosslinking agent in side chains. Here, the crosslinkable functional group may react with the crosslinking agent. For example, the crosslinkable functional group may include —SO₂—OH.

According to another embodiment of the present disclosure, the polymer electrolyte membrane may be in the form of a single-layer membrane.

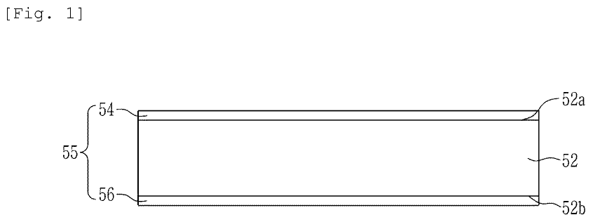

The polymer electrolyte membrane according to another embodiment of the present disclosure may include a porous support, wherein the porous support may be impregnated with the ion conductor polymer dispersion. The polymer electrolyte membrane may be a reinforced composite membrane in the form of a composite membrane. As used herein, the term “impregnation” is defined as the ion conductor dispersion having permeated into the internal pores of a porous support. Hereinafter, the configuration of the present disclosure will be described in detail with reference to FIG. 1.

FIG. 1 a cross-sectional view showing a polymer electrolyte membrane according to an embodiment of the present disclosure.

Referring to FIG. 1, a porous support 52 according to the present disclosure may be a fluorine-based support or a nanoweb support.

The fluorine-based support may be, for example, expanded polytetrafluoroethylene (e-PTFE) having a microstructure of polymer fibrils, or a microstructure in which nodes are interconnected by fibrils. In addition, a film having a microstructure of polymer fibrils without nodes may also be used as the porous support 52.

The fluorine-based support may include a perfluorinated polymer. The porous support 52 may be a more porous and stronger porous support obtained by extruding dispersion-polymerized PTFE into a tape in the presence of a lubricant, and stretching the resulting material.

Additionally, the amorphous content of the PTFE may be increased by heat-treating the e-PTFE at a temperature exceeding the melting point of PTFE (about 342° C.). The e-PTFE film manufactured by the above method may have micropores with various diameters and porosity. The e-PTFE film manufactured by the above method may have a porosity of at least 35%, and a diameter of the micropores may be about 0.01 to 1 μm (micrometers).

The nanoweb support according to an embodiment of the present disclosure may be a non-woven fibrous web composed of a plurality of randomly oriented fibers. The non-woven fibrous web refers to a sheet having a structure of individual fibers or filaments that are interlaid, but not in the same manner as a woven fabric. The non-woven fibrous web may be manufactured by any one method selected from the group consisting of carding, garneting, air-laying, wet-laying, melt blowing, spun bonding, and stitch bonding.

The fibers may include one or more polymeric materials, and any material that is generally used as a fiber-forming polymer material may be used, and specifically, a hydrocarbon-based fiber-forming polymer material may be used. For example, the fiber-forming polymeric material may include any one selected from the group consisting of polyolefins such as polybutylene, polypropylene, and polyethylene, polyesters such as polyethylene terephthalate and polybutylene terephthalate, polyamides (nylon-6 and nylon-6,6), polyurethane polybutene, polylactic acid, polyvinyl alcohol, polyphenylene sulfide, polysulfones, liquid crystalline polymers, polyethylene-co-vinyl acetate, polyacrylonitrile, cyclic polyolefins, polyoxymethylene, polyolefin-based thermoplastic elastomers, and combinations thereof. However, the technical scope of the present disclosure is not limited thereto.

The nanoweb support according to an embodiment of the present disclosure may be a support in which nanofibers are integrated in a nonwoven form containing a plurality of pores.

The nanofibers exhibit excellent chemical resistance and hydrophobicity, so a hydrocarbon-based polymer that does not pose a risk of shape deformation due to moisture in a high-humidity environment may be preferably used.

Specifically, as the hydrocarbon-based polymers, a polymer selected from the group consisting of nylon, polyimide, polyaramid, polyetherimide, polyacrylonitrile, polyaniline, polyethylene oxide, polyethylene naphthalate, polybutylene terephthalate, styrene butadiene rubber, polystyrene, polyvinyl chloride, polyvinyl alcohol, polyvinylidene fluoride, polyvinyl butylene, polyurethane, polybenzoxazole, polybenzimidazole, polyamideimide, polyethylene terephthalate, polyphenylene sulfide, polyethylene, polypropylene, copolymers thereof, and a mixture thereof may be used.

The nanoweb support is a collection of nanofibers randomly arranged and manufactured by electrospinning. In this case, considering the porosity and thickness of the nanoweb, the nanofibers preferably have an average diameter of 40 to 5,000 nm (nanometers) when the average diameter of 50 fibers is measured using a scanning electron microscope (JSM6700F, JEOL) and calculated from the average.

When the average diameter of the nanofibers is less than the above range, the mechanical strength of the porous support may be reduced, and when the average diameter of the nanofibers exceeds the above range, the porosity may be significantly reduced, and the thickness may be increased.

The thickness of the non-woven fibrous web may be 10 to 50 μm (micrometers), and specifically, 15 to 43 μm. When the thickness of the non-woven fibrous web is less than the above range, the mechanical strength may be reduced, and when the thickness of the non-woven fibrous web exceeds the above range, resistance loss may increase, and weight reduction and integration may be reduced.

The nonwoven fibrous web may have a basic weight of 5 to 30 g/m². When the basic weight of the nonwoven fibrous web is less than the above range, visible pores may be formed, making it difficult to function as a porous support. When the basic weight of nonwoven fibrous web exceeds the above range, it may be manufactured in the form of paper or fabric, in which pores are hardly formed.

The porosity may be calculated by the ratio of the air volume to the total volume of the metal porous support according to Equation 1 below. In this case, the total volume may be calculated by preparing a rectangular sample and measuring its width, length, and thickness. The air volume may be obtained by measuring the mass of the sample and then subtracting the polymer volume calculated inversely from the density, from the total volume.

$$Porosity ( \% ) = ( air volume in porous support / total volume of porous support ) ⨯ 100 \qquad [ Equation l ]$$

The porosity of the porous support 52 according to the present disclosure may be 30 to 90%, and preferably 60 to 85%. When the porosity of the porous support 52 is less than the above range, the impregnation property of the ion conductor may be reduced, and when the porosity of the porous support 52 exceeds the above range, the shape stability may be reduced, and thus a subsequent process may not be smoothly performed.

A polymer electrolyte membrane 50 according to the present disclosure may include a first resin layer 54 and a second resin layer 56 opposite to the first resin layer 54. Specifically, the first resin layer 54 may be disposed on a first surface 52a of the porous support 52, and the second resin layer 56 may be disposed on a second surface 52b opposite to the first surface 52a. Accordingly, an ion conductor layer 55 may be formed on the surface of the porous support 52, and may include the above-mentioned ion conductor.

According to an embodiment of the present disclosure, the tensile strength of the polymer electrolyte membrane 50 may be 25 to 90 MPa, 30 to 85 MPa, 35 to 82 MPa, 40 to 82 MPa, or 50 to 82 MPa. For example, the tensile strength of the polymer electrolyte membrane may be measured using a universal testing machine (SHM-C-500, Shamhan Tech, Republic of Korea) according to the ASTM D882 method. Specifically, the means for achieving the tensile strength of the polymer electrolyte membrane may vary depending on the composition of the ion conductor polymer dispersion.

### 3. Membrane-Electrode Assembly

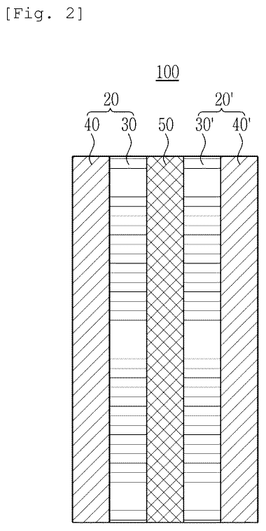

FIG. 2 is a cross-sectional view showing a membrane-electrode assembly according to an embodiment of the present disclosure. The above-mentioned parts and repeated descriptions will be briefly described or omitted.

Referring to FIG. 2, a membrane-electrode assembly 100 according to the present disclosure is a membrane-electrode assembly including a polymer electrolyte membrane 50, and includes an anode 20 and a cathode 20′ located to face each other, and a polymer electrolyte membrane 50 located between the anode 20 and the cathode 20′.

The anode and cathode 20 and 20′ may include electrode substrates 40 and 40′, and catalyst layers 30 and 30′ formed on the surface of the electrode substrates 40 and 40′, and may further include a microporous layer (not shown) located between the electrode substrates 40 and 40′ and the catalyst layers 30 and 30′ and including conductive fine particles such as carbon powder or carbon black in order to facilitate material diffusion in the electrode substrates 40 and 40′.

The catalyst layers 30 and 30′ of the anode and cathode 20 and 20′, include a catalyst. As the catalyst, any material capable of participating in the cell reaction and commonly usable in a fuel cell may be used. Preferably, a platinum-based metal may be used.

The platinum-based metal may include one selected from the group consisting of platinum (Pt), palladium (Pd), ruthenium (Ru), iridium (Ir), osmium (Os), a platinum-M alloy, a non-platinum alloy, and combinations thereof. More preferably, a combination of two or more metals selected from the platinum-based metal group may be used, but is not limited thereto, and any platinum-based catalyst metal usable in the art may be used without limitation.

The M may be any one selected from the group consisting of palladium (Pd), ruthenium (Ru), iridium (Ir), osmium (Os), gallium (Ga), titanium (Ti), vanadium (V), chromium (Cr), manganese (Mn), iron (Fe), cobalt (Co), nickel (Ni), copper (Cu), silver (Ag), gold (Au), zinc (Zn), tin (Sn), molybdenum (Mo), tungsten (W), lanthanum (La), and rhodium (Rh). Specifically, the platinum alloy may be used alone or in combination of two or more selected from the group consisting of Pt—Pd, Pt—Sn, Pt—Mo, Pt—Cr, Pt—W, Pt—Ru, Pt—Ru—W, Pt—Ru—Mo, Pt—Ru—Rh—Ni, Pt—Ru—Sn—W, Pt—Co, Pt—Co—Ni, Pt—Co—Fe, Pt—Co—Ir, Pt—Co—S, Pt—Co—P, Pt—Fe, Pt—Fe—Ir, Pt—Fe—S, Pt—Fe—P, Pt—Au—Co, Pt—Au—Fe, Pt—Au—Ni, Pt—Ni, Pt—Ni—Ir, Pt—Cr, Pt—Cr—Ir, and combinations thereof.

In addition, the non-platinum alloys may be used alone or in combination of two or more selected from the group consisting of Ir—Fe, Ir—Ru, Ir—Os, Co—Fe, Co—Ru, Co—Os, Rh—Ir—Ru—Fe, Ir—Ru—Os, Rh—Ru—Fe, Rh—Ru—Os, Fe, Rh—Ru, Rh—Os, and combinations thereof.

The catalyst may be used as the catalyst itself (black) or may be used by supporting it on a carrier.

### 4. Fuel Cell

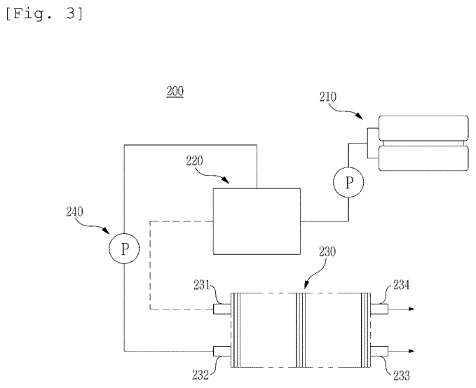

FIG. 3 is a schematic view for illustrating a fuel cell according to an embodiment of the present disclosure.

Another embodiment of the present disclosure is a fuel cell including the membrane-electrode assembly.

Referring to FIG. 3, the fuel cell 200 according to the present disclosure may include a fuel supply unit 210 for supplying a mixed fuel of fuel and water, a reforming unit 220 for reforming the mixed fuel to generate a reformed gas containing hydrogen gas, a stack 230 for generating electrical energy by causing an electrochemical reaction between the reformed gas containing hydrogen gas supplied from the reforming unit 220 and an oxidant, and an oxidant supply unit 240 for supplying the oxidant to the reforming unit 220 and the stack 230.

The stack 230 may include a plurality of unit cells for generating electrical energy by inducing oxidation/reduction reactions between a reformed gas containing hydrogen gas supplied from the reforming unit 220 and an oxidant supplied from the oxidant supply unit 240.

Each unit cell refers to a cell unit for generating electricity, and may include a membrane-electrode assembly for oxidizing/reducing oxygen in the reforming gas containing hydrogen gas and the oxidant, and a separator (also referred to as a bipolar plate, hereinafter referred to as a ‘separator’) for supplying the reformed gas containing hydrogen gas and the oxidant to the membrane-electrode assembly. The separators are disposed on both sides of the membrane-electrode assembly with the membrane-electrolyte membrane interposed therebetween. In this case, the separators respectively located at the outermost sides of the stack are also specifically referred to as end plates.

Among the separators, the end plate may include a first supply pipe 231 in the shape of a pipe for injecting reformed gas containing hydrogen gas supplied from the reforming unit 220, and a second supply pipe 232 in the shape of a pipe for injecting oxygen gas. The other end plate may include a first discharge pipe 233 for discharging reformed gas containing hydrogen gas that is ultimately unreacted and remains, from a plurality of unit cells to the outside, and a second discharge pipe 234 for discharging an oxidizer that is ultimately unreacted and remains, from the above unit cells to the outside.

In the fuel cell, the separator, fuel supply unit, and oxidant supply unit constituting the power generation unit are used in a conventional fuel cell. Therefore, a detailed description thereof will be omitted herein.

Hereinafter, Examples of the present disclosure will be described in detail to enable those skilled in the art to easily carry out the present disclosure. However, these Examples are merely one example, and the scope of the present disclosure is not limited to the contents described below.

### Manufacturing Example 1: Preparation of Ion Conductor Dispersion

An ion conductor dispersion as shown in Table 1 below was prepared.

TABLE 1

| | Comparative | Comparative | | | | |
|---|---|---|---|---|---|---|
| Unit: part | Manufacturing | Manufacturing | Manufacturing | Manufacturing | Manufacturing | Manufacturing |
| by weight | Example 1 | Example 2 | Example 1 | Example 2 | Example 3 | Example 4 |
| Fluorine- | 100 | — | 100 | 100 | — | — |
| based ion | | | | | | |
| conductor¹⁾ | | | | | | |
| Hydrocarbon- | — | 100 | — | — | 100 | 100 |
| based ion | | | | | | |
| conductor²⁾ | | | | | | |
| Salicyl | — | — | 1 | — | 1 | — |
| salicylic | | | | | | |
| acid | | | | | | |
| Acetyl | — | — | — | 1 | — | 1 |
| salicylic | | | | | | |
| acid | | | | | | |
| Propan-1- | 300 | — | 300 | 300 | — | — |
| ol:ethanol:dis- | | | | | | |
| tilled water | | | | | | |
| (Weight | | | | | | |
| ratio of | | | | | | |
| 1:1::1) | | | | | | |
| Dimethyl | — | 650 | — | — | 650 | 650 |
| acetamide | | | | | | |
| (DMAc) | | | | | | |

¹⁾Perfluorosulfonic acid (PFSA)
²⁾Sulfonated poly(ether sulfone) (S-PES) with a degree of sulfonation of 60% and an ion exchange capacity of 1.6 meq/g

### Experimental Example 1: Contact Angle with Respect to PTFE (Polytetrafluoroethylene) Porous Membrane

The contact angle of the ion conductor dispersion according to the Manufacturing Example 1 with respect to the polytetrafluoroethylene (PTFE) porous membrane (trade name: PTFE substrate of Teflon) was measured.

While maintaining 25° C. and RH 60%, the ion conductor dispersion according to the Manufacturing Example 1 was filled into a syringe and a 5 μl volume of liquid droplet was dropped on the PTFE porous membrane. Then, the liquid droplet was allowed to spread for 1 second, and after 1 second had elapsed, the contact angle formed between the PTFE porous membrane and the liquid droplet was measured using a contact angle goniometer (measuring device: Model 190 from Technox Co., Ltd.).

TABLE 2

| | Comparative | Comparative | | | | |
|---|---|---|---|---|---|---|
| | Manufacturing | Manufacturing | Manufacturing | Manufacturing | Manufacturing | Manufacturing |
| Sample | Example 1 | Example 2 | Example 1 | Example 2 | Example 3 | Example 4 |
| Contact | 118 | 87 | 117 | 118 | 88 | 86 |
| angle (°) | | | | | | |

### Manufacturing Example 2: Manufacturing of Polymer Electrolyte Membrane

A polymer electrolyte membrane was manufactured using the ion conductor dispersion according to Manufacturing Example 1. In the following Comparative Examples and Examples, drying and crosslinking were performed simultaneously.

### Comparative Example 1

### The Ion Conductor Dispersion According to Comparative

Manufacturing Example 1 in Table 1 was formed into a film on a glass substrate, and then dried at 90° C. for 12 hours to manufacture a polymer electrolyte membrane.

### Comparative Example 2

### The Ion Conductor Dispersion According to Comparative

Manufacturing Example 2 was formed into a film on a glass substrate, and then dried at 90° C. for 24 hours to manufacture a polymer electrolyte membrane.

### Comparative Example 3

The ion conductor dispersion according to the Comparative Manufacturing Example 1 was impregnated into an expanded-polytetrafluoroethylene (e-PTFE) support having an average pore size of 0.2 μm and a porosity of 75%. Subsequently, the impregnated polytetrafluoroethylene (PTFE) support was dried at 90° C. for 12 hours to manufacture a polymer electrolyte membrane (or a reinforced composite membrane).

### Comparative Example 4

The ion conductor dispersion according to the Comparative Manufacturing Example 2 was impregnated into a polyphenylene sulfide (PPS) support having an average pore size of 0.2 μm and a porosity of 70%. Subsequently, the impregnated resultant was dried at 90° C. for 24 hours to manufacture a polymer electrolyte membrane (or a reinforced composite membrane).

### Examples 1 and 2

The ion conductor dispersions according to the Manufacturing Examples 1 and 2 were respectively formed into films on glass substrates, and then dried at 90° C. for 12 hours to manufacture polymer electrolyte membranes, respectively.

### Examples 3 and 4

The ion conductor dispersions according to the above Manufacturing Examples 3 and 4 were respectively formed into films on glass substrates, and then dried at 90° C. for 24 hours to manufacture polymer electrolyte membranes, respectively.

### Example 5

A polymer electrolyte membrane (or a reinforced composite membrane) was manufactured using the same manner as in Comparative Example 3, except that the ion conductor dispersion according to Manufacturing Example 1 was used instead of the ion conductor dispersion according to Comparative Manufacturing Example 1.

### Example 6

A polymer electrolyte membrane (or a reinforced composite membrane) was manufactured using the same manner as in Comparative Example 3, except that the ion conductor dispersion according to Manufacturing Example 2 was used instead of the ion conductor dispersion according to Comparative Manufacturing Example 1.

### Example 7

A polymer electrolyte membrane (or a reinforced composite membrane) was manufactured using the same manner as in Comparative Example 4, except that the ion conductor dispersion according to Manufacturing Example 3 was used instead of the ion conductor dispersion according to Comparative Manufacturing Example 2.

### Example 8

A polymer electrolyte membrane (or a reinforced composite membrane) was manufactured using the same manner as in Comparative Example 4, except that the ion conductor dispersion according to Manufacturing Example 4 was used instead of the ion conductor dispersion according to Comparative Manufacturing Example 2.

### Experimental Example 2: Tensile Strength Evaluation of Polymer Electrolyte Membrane

The tensile strength of the polymer electrolyte membrane according to the Manufacturing Example 2 was measured using a universal testing machine (SHM-C-500, Shamhan Tech, Republic of Korea) according to the ASTM D882 method.

TABLE 3

| | Tensile |
|---|---|
| | Strength (MPa) |
| Comparative | 23.7 |
| Example 1 | |
| Comparative | 47.9 |
| Example 2 | |
| Comparative | 50.1 |
| Example 3 | |
| Comparative | 71.2 |
| Example 4 | |
| Example 1 | 28.5 |
| Example 2 | 27.2 |
| Example 3 | 54.9 |
| Example 4 | 55.3 |
| Example 5 | 53.6 |
| Example 6 | 54.6 |
| Example 7 | 80.6 |
| Example 8 | 81.0 |

Referring to Table 3 above, it can be confirmed that the tensile strength in the Examples was significantly improved compared to the Comparative Examples. From this, it can be inferred that the mechanical durability of the polymer electrolyte membrane or the reinforced composite membrane was significantly improved by the introduction of the crosslinking agent.

### Experimental Example 3: OCV Decrease Rate as Results of DOE Chemical Durability Evaluation of Membrane-Electrode Assembly

Electrodes manufactured by a decal method were attached onto both surfaces of the polymer electrolyte membrane (or the reinforced composite membrane) according to Manufacturing Example 2, and an electrode slurry (catalyst: Pt/C, Pt loading content: 0.4 mg/cm²) was directly coated thereon to manufacture a membrane-electrode assembly. The chemical durability of the membrane-electrode assembly was evaluated based on the durability evaluation protocol of the U.S. Department of Energy (DOE). Specifically, the voltage loss was measured after performing the OCV hold method for 500 hours under conditions of 120° C. and RH 20%, and the measured values are shown in Table 4 below.

TABLE 4

| | OCV Voltage |
|---|---|
| | loss (%) |
| Comparative | 23.7 |
| Example 1 | |
| Comparative | 30.8 |
| Example 2 | |
| Comparative | 20.5 |
| Example 3 | |
| Comparative | 24.4 |
| Example 4 | |
| Example 1 | 19.2 |
| Example 2 | 19.1 |
| Example 3 | 17.6 |
| Example 4 | 17.8 |
| Example 5 | 15.6 |
| Example 6 | 15.4 |
| Example 7 | 19.4 |
| Example 8 | 20.2 |

Referring to Table 4, it can be inferred that the OCV voltage loss in the Examples was relatively smaller than in the Comparative Examples, and thus chemical durability was improved overall.

Although the preferred embodiments of the present disclosure have been described in detail above, the scope of the rights of the present disclosure is not limited thereto, and various modifications and improvements made by those skilled in the art using the basic concept of the present disclosure defined in the following claims also fall within the scope of the rights of the present disclosure.

1. An ion conductor dispersion comprising:
an ion conductor;
a crosslinking agent; and
a solvent,
wherein a contact angle measured 1 second after the ion conductor dispersion is dropped on a polytetrafluoroethylene (PTFE) porous membrane under conditions of 25° C. and a relative humidity of 60% is 135° or less.

2. The ion conductor dispersion of claim 1, wherein the ion conductor is any one selected from the group consisting of a fluorine-based ion conductor, a partially fluorine-based ion conductor, a hydrocarbon-based ion conductor, and a mixture thereof.

3. The ion conductor dispersion of claim 1, wherein the crosslinking agent includes any one selected from the group consisting of a salicylic acid-based compound, a coumaric acid-based compound, terephthalic acid, 3-hydroxybenzoic acid, 4-hydroxybenzoic acid, and combinations thereof.

4. The ion conductor dispersion of claim 3, wherein the salicylic acid-based compound includes any one selected from the group consisting of salicylsalicylic acid, acetylsalicylic acid, and combinations thereof.

5. The ion conductor dispersion of claim 1, wherein the crosslinking agent is included in an amount of 0.05 to 20 parts by weight, based on 100 parts by weight of the ion conductor.

6. The ion conductor dispersion of claim 1, wherein the solvent is any one selected from the group consisting of a polar solvent, a non-polar solvent, and a mixture thereof.

7. The ion conductor dispersion of claim 6, wherein the polar solvent is any one selected from the group consisting of distilled water, an alcohol solvent, tetrahydrofuran, 1,4-dioxane, dimethyl acetamide, dimethyl formamide, dimethyl sulfoxide, methylene chloride, and a mixture thereof.

8. The ion conductor dispersion of claim 6, wherein the nonpolar solvent is any one selected from the group consisting of n-hexane, 1,1,2,2-tetrachloroethane, 1,2-dichloroethane, chloroform, and a mixture thereof.

9. The ion conductor dispersion of claim 1, wherein a solubility of the crosslinking agent in the solvent is 0.5 to 400 g/L under conditions of 20 to 30° C. and a relative humidity of 50 to 70%.

10. The ion conductor dispersion of claim 1, wherein a dielectric constant of the solvent is 48 or less.

11. A polymer electrolyte membrane manufactured using the ion conductor dispersion of claim 1.

12. The polymer electrolyte membrane of claim 11,
wherein the polymer electrolyte membrane includes a porous support, and
wherein the porous support is impregnated with the ion conductor dispersion.

13. A membrane-electrode assembly comprising:
the polymer electrolyte membrane of claim 11; and
a catalyst layer disposed on at least one surface of the polymer electrolyte membrane.

14. A fuel cell comprising the membrane-electrode assembly of claim 13.
